(19) United States
(12) Patent Application Publication
(10) Pub. No.: US 2006/0270765 A1
(43) Pub. Date: Nov. 30, 2006

(54) Novel stabilizer system for halogenous polymers

(76) Inventors: Wolfgang Wehner, Zwingenberg (DE); Hans-Helmut Friedrich, Lautertal-Gadernheim (DE)

Correspondence Address: Michael P. Dilworth, Chemtura Corporation 199 Benson Road, Middlebury, CT, 06749, US

(21) Appl. No.: 10/552,917

(22) PCT Filed: Apr. 7, 2004
(86) PCT No.: PCT/EP04/03697

§ 371 Date: Oct. 13, 2005

(30) Foreign Application Priority Data
Apr. 17, 2003 (DE) 103 17 870.8

(51) Int. Cl. C08K 5/34

(52) U.S. Cl. 524/106; 524/104; 524/155; 524/211; 524/236

(57) ABSTRACT

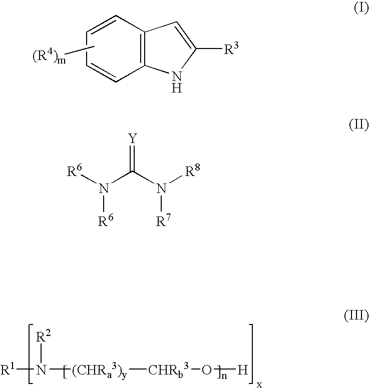

The invention relates to stabilising systems for stabilising chlorinated polymers. The inventive stabilising systems contain a) at least one type of perfluoroalkane sulfonate salt and b) at least one or several indoles of general formula (I) and/or urea of general formula (II) and/or alcanolamines of general formula (III) and/or amonouracils.

The invention relates to stabilizer systems encompassing at least one perfluoroalkanesulphonate salt and at least one or more compounds from the groups consisting of the indoles, ureas, alkanolamines and aminouracils, which are suitable for stabilizing halogen-containing polymers.

A halogen-containing polymer, such as PVC, may be stabilized by any of a large number of additives. Compounds of lead, of barium, and of cadmium are particularly well suited to this purpose, but are nowadays controversial for environmental reasons or because of their heavy metal content (cf. “Plastics Additives Handbook”, H. Zweifel, Carl Hanser Verlag, 5th Edition, 2001, pp. 427-483, and “Kunststoff Handbuch PVC” [Plastics Handbook PVC], Volume 2/1, W. Becker and D. Braun, Carl Hanser Verlag, 2nd Edition, 1985, pp. 531-538; and Kirk-Othmer: “Encyclopedia of Chemical Technology”, 4th Edition, 1994, Vol. 12, Heat Stabilizers, pp. 1071-1091).

There is therefore a continuing search for effective stabilizers and stabilizer systems which are free from lead, barium and cadmium.

It has now been found that systems made from at least one or more compounds from the groups consisting of the indoles, ureas, alkanolamines and aminouracils and from at least one perfluoroalkanesulphonate salt, are particularly highly suitable for stabilizing chlorine-containing polymers, in particular PVC.

The invention accordingly provides stabilizer systems comprising at least
a) one perfluoroalkanesulphonate salt and
b) at least one or more indoles and/or ureas and/or alkanolamines and/or aminouracils
where the indoles have the general formula (I) 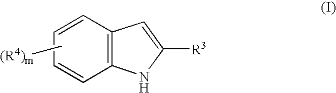
where
m=0, 1, 2 or 3;
R³=C₁-C₁₈-alkyl, C₂-C₁₈-alkenyl, phenyl or 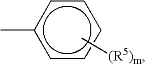
C₇-C₂₄-alkylphenyl, C₇-C₁₀-phenylalkyl or C₁-C₄-alkoxy; R⁴, R⁵=H, C₁-C₄-alkyl, or C₁-C₄-alkoxy;
where the ureas have the general formula (II) 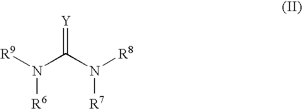
where
Y=O, S or NH;
R⁶, R⁷, R⁸ and R⁹, independently of one another, are H,
C₁-C₁₈-alkyl, where appropriate substituted with hydroxy groups and/or C₁-C₄-alkoxy groups, C₂-C₁₈-alkenyl,
phenyl, where appropriate substituted with up to 3 hydroxy and/or C₁-C₄-alkyl/alkoxy groups,
C₇-C₂₀-alkylphenyl or
C₇-C₁₀-phenylalkyl and 2-substituents selected from R⁶ to R⁹, where these may also form a ring,
and the urea used may also be a dimerized or trimerized urea, e.g. biuret or 1,3,5-tris(hydroxyalkyl)isocyanurate and possible reaction products of these
where the alkanolamines have the formula (III)

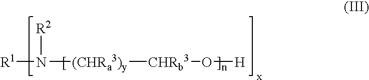

where
x=1, 2 or 3;
y=1, 2, 3, 4, 5 or 6;
n=1-10;
R¹ and R²=independently of one another
H,
C₁-C₂₂-alkyl,
—[—(CHR³ₐ)_{y}—CHR³_{b}—O—]ₙ—H,
—[—(CHR³ₐ)_{y}—CHR³_{b}—O—]ₙ—CO—R⁴,
C₂-C₂₀-alkenyl,
C₂-C₁₈-acyl,
C₄-C₈-cycloalkyl, which may have OH substitution in the β-position,
phenyl,
C₇-C₁₀-alkylphenyl or C₇-C₁₀-phenylalkyl,
or if
x=1, R¹ and R² may also form, together with the N, a closed 4-10-membered ring of carbon atoms and, where appropriate, of up to 2 heteroatoms, or if x=2, R¹ may also be C₂-C₁₈-alkylene which may have OH substitution at the two β-carbon atoms and/or may have interruption by one of more O atoms and/or by one or more NR² groups, or may be dihydroxy-substituted tetrahydrodicyclopentadienylene, dihydroxy-substituted ethylcyclohexanylene, dihydroxy-substituted 4,4′-(bisphenol-A-dipropyl ether)ylene, isophoronylene, dimethylcyclohexanylene, dicyclohexylmethanylene or 3,3′-dimethyldicyclohexylmethanylene, and if x=3, R¹ may also be trihydroxy-substituted (tri-N-propyl isocyanurate)triyl;
R³ₐ and R³_{b}=independently of one another,
C₁-C₂₂-alkyl,
C₂-C₆-alkenyl,
phenyl,
C₆-C₁₀-alkylphenyl,
H or
CH₂—X—R⁵,
where X=O, S, —O—CO— or —CO—O—;
R⁴=C₁-C₁₈-alkyl/alkenyl or phenyl; and
R=H, C₁-C₂₂-alkyl, C₂-C₂₂-alkenyl, phenyl or C₆-C₁₀-alkylphenyl,
and the aminouracils have the formula (IVa) or (IVb) 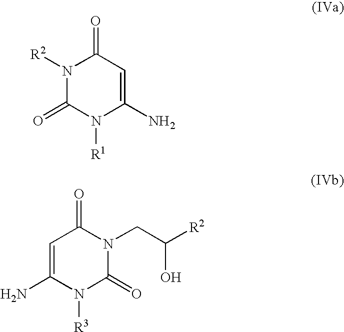
where in the case of (IVa) R¹ and R², independently of one another, are
H,
unsubstituted or C₁-C₄-alkyl-C₁-C₄-alkoxy- and/or hydroxy-substituted phenyl, or are phenyl-C₁-C₄-alkyl which is unsubstituted or has
C₁-C₄-alkyl,
C₁-C₄-alkoxy and/or
hydroxy substitution
on the phenyl ring,
C₃-C₆-alkenyl,
C₅-C₈-cycloalkyl, or are C₃-C₁₀-alkyl interrupted by at least one oxygen atom,
or are CH₂—CHOH—R³,
R³=H or
C₁-C₄-alkyl,
C₂-C₄-alkenyl
C₄-C₈-cycloalkyl,
phenyl,
C₇-C₁₀-alkylphenyl or
C₇-C₁₀-phenylalkyl,
and in the case of N- or N′-monosubstituted aminouracils R¹ or R² is also C₃-C₂₂-alkyl, and in the case of (IVb) R²=H or the radicals C₁-C₄-alkyl, C₂-C₄-alkenyl, or C₄-C₈-cycloalkyl, phenyl, C₆-C₁₀-alkylphenyl, C₇-C₁₀-phenylalkyl, —CH₂—X—R⁴, where
R⁴=H, a C₁-C₁₀-alkyl or
a C₂-C₄-alkenyl radical or
C₄-C₈-cycloalkyl, where appropriate also containing an oxirane ring; or where appropriate substituted with from 1 to 3 C₁-C₄-alkyl radicals, or with a benzoyl radical or C₂-C₁₈-acyl radical, and X=O or S;
R³=R² or R⁴; C₂-C₆-alkyl substituted with at least 1-50H groups and/or interrupted by at least 1 to a maximum of 4 O atoms, or is CH₂—CH(OH)R² for stabilizing chlorine-containing polymers.
In addition to compounds of the formulae (I) to (III), at least one compound of the formula (IVa) may also be present, where R¹=R²=C₁-C₂₂-alkyl or oleyl, and these aminouracils may moreover have been replaced entirely or to some extent by a corresponding structurally isomeric cyanoacetylurea. Preferred C₁-C₂₂-alkyl is methyl, butyl, octyl, lauryl and stearyl. The corresponding cyanoacetylureas are N-methyl-, -butyl-, -octyl-, -lauryl- or -stearyl-N′-methyl-, -butyl-, -octyl-, -lauryl- or -stearylcyanoacetylurea.

The perfluoroalkanesulphonate salts of the formula (R_{f}SO₃)ₙM are known to the person skilled in the art.

The underlying acids, and also salts, are described in Kirk Othmer, Encyclopedia of Chemical Technology, 4th Ed., John Wiley & Sons, New York, Vol 11, pp 558-564 (1994).

Examples are those of the formula (CₘF₂ₘ₊₁SO₃)ₙM where M is Li, Na, K, Mg, Ca, Sr, Ba, Sn, Zn, Al, La or Ce. The index n is correspondingly the valency of M: 1, 2 or 3. The perfluoroalkanesulphonate salts here may be used in various familiar supply forms; e.g. as a salt or solution in water or in an organic solvent, or absorbed onto a carrier material, such as PVC, Ca silicate, zeolites or hydrotalcites. Examples are perfluoro-alkanesulphonate salts which have been converted to complexes or solutions using alcohols (polyols, cyclodextrins) or using ether alcohols or using ester alcohols or using crown ethers.

Trifuoromethanesulphonic acid (“triflic acid”) and its salts (“triflates”) are reviewed in Chem. Rev. 77, 69-90 (1977), for example.

It is preferable to use sodium triflate or potassium triflate.

The invention also provides combinations of the stabilizer systems encompassing at least one perfluoroalkanesulphonate salt and at least one or more compounds from the groups consisting of the compounds of the general formula (I) or (II) or (III) or (IV) with at least one or more other conventional additives or stabilizers. Preference is given to polyols and/or disaccharide alcohols, glycidyl compounds, hydrotalcites, zeolites (alkali metal aluminosilicates and alkaline earth metal aluminosilicates), fillers, metal soaps, alkali metal and alkaline earth metal compounds, such as oxides and hydroxides, lubricants, plasticizers, phosphites, hydroxycarboxylates, pigments, epoxidized fatty esters and other epoxy compounds, antioxidants, UV absorbers and light stabilizers, optical brighteners and blowing agents. Particular preference is given to epoxidized soya oils, alkaline earth metal or aluminium soaps and phosphites.

Particular preference is given to those components which are suitable for producing physiologically non-hazardous products.

Also included are the possible reaction products of the components used.

Examples of additional components of this type are listed and explained at a later stage below (cf. “Handbook of PVC Formulating” by E. J. Wickson, John Wiley & Sons, New York, 1993 and Synoptic Document No. 7, Scientific Committee for Food (SCF)-EU).

Polyols and Disaccharide Alcohols

Examples of possible compounds of this type are: glycerol, pentaerythritol, dipentaerythritol, tripentaerythritol, trimethylolethane, bis(trimethylolpropane), polyvinyl alcohol, bis(trimethylolethane), trimethylolpropane, sugars, sugar alcohols.

Of these, preference is given to pentaerythritol, trimethylolpropane, sorbitol and the disaccharide alcohols such as Malbit, lactitol and cellobiitol, and also Palatinit.

It is also possible to use polyol syrups, such as sorbitol syrup, mannitol syrup and maltitol syrup. Examples of the amounts of the polyols used are from 0.01 to 20 parts by weight, advantageously from 0.1 to 20 parts by weight and in particular from 0.1 to 10 parts by weight, based on 100 parts by weight of PVC.

Glycidyl Compounds

These contain the glycidyl group 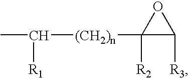
bonded directly to carbon: oxygen, nitrogen or sulphur atoms, either where both of R₁ and R₃ are hydrogen, R₂ is hydrogen or methyl and n=0 or where R₁ and R₃ together are —CH₂—CH₂— or —CH₂—CH₂—CH₂—, R₂ then being hydrogen and n being 0 or 1.

It is preferable to use glycidyl compounds having two functional groups. However, it is also possible in principle to use glycidyl compounds having one, three or more functional groups.

Use is predominantly made of diglycidyl compounds having aromatic groups.

The amounts used of the terminal epoxy compounds are preferably at least 0.1 part, preferably from 0.1 to 50 parts by weight, advantageously from 1 to 30 parts by weight and in particular from 1 to 25 parts, based on 100 parts by weight of PVC.

Hydrotalcites

The chemical composition of these compounds is known to the skilled worker, e.g. from the patents DE 3 843 581, U.S. Pat. No. 4,000,100, EP 0 062 813 and WO 93/20135.

Compounds from the hydrotalcite series may be described by the following general formula
M²⁺₁₋ₓM³⁺ₓ(OH)₂(A^{b-})_{x/b}.dH₂O,
where
M²⁺=one or more of the metals selected from the group consisting of Mg, Ca, Sr, Zn and Sn
M³⁺=Al or B.
Aⁿ an anion of valency n,

b is a number from 1-2,

0<x<0.5,

d is a number from 0-20.

Preference is given to compounds with

Aⁿ=OH⁻, ClO₄⁻, HCO₃⁻, CH₃COO⁻, C₆H₅COO⁻, CO₃²⁻, (CHOHCOO)₂²⁻, (CH₂COO)₂²⁻, CH₃CHOHCOO⁻, HPO₃⁻ or HPO₄²⁻;

Examples of hydrotalcites are

Al₂O₃.6MgO.CO₂.12H₂O (i), Mg_{4.5}Al₂(OH)₁₃.CO₃.3.5H₂O (ii), 4MgO.Al₂O₃.CO₂.9H₂O (iii), 4MgO.Al₂O₃.CO₂.6H₂O, ZnO.3MgO.Al₂O₃.CO₂.8-9H₂O and ZnO.3MgO.Al₂O₃.CO₂.5-6H₂O.

Very particular preference is given to types (i), (ii) and (iii).

Zeolites (Aluminosilicates of Alkali Metals and/or of Alkaline Earth Metals)

These may be described by the following general formula

M_{x/n}[(AlO₂)ₓ(SiO₂)_{y}].wH₂O, where n is the charge on the cation M;

M is an element of the first or second main group, such as Li, Na, K, Mg, Ca, Sr or Ba;

y: x is a number from 0.8 to 15, preferably from 0.8 to 1.2; and

w is a number from 0 to 300, preferably from 0.5 to 30.

Examples of zeolites are sodium aluminosilicates of the formulae

Na₁₂Al₁₂Si₁₂O₄₈.27 H₂O [zeolite A], Na₆Al₆Si₆O₂₄.2 NaX.7.5 H₂O, X=OH, halogen, ClO₄ [sodalite]; Na₆Al₆Si₃₀O₇₂.24 H₂O; Na₈Al₈Si₄₀O₉₆.24H₂O; Na₁₆Al₁₆Si₂₄O₈₀.16 H₂O; Na₁₆Al₁₆Si₃₂O₉₆.16 H₂O; Na₅₆Al₅₆Si₁₃₆O₃₈₄.250 H₂O [zeolite Y], Na₈₆Al₈₆Si₁₀₆O₃₈₄.264 H₂O [zeolite XI

or the zeolites which can be prepared by partial or complete exchange of the Na atoms by Li atoms, K atoms, Mg atoms, Ca atoms, Sr atoms or Zn atoms, for example (Na,K)₁₀Al₁₀Si₂₂O₆₄.20 H₂O; Ca_{4.5}Na₃[(AlO₂)₁₂(SiO₂)₁₂]*30 H₂O; K₉Na₃[(AlO₂)₁₂(SiO₂)₁₂].27 H₂O.

Very particular preference is given to Na zeolite A and Na zeolite P.

The hydrotalcites and/or zeolites may be used in amounts of, for example, 0.1 to 20 parts by weight, expediently 0.1 to 10 parts by weight and in particular 0.1 to 5 parts by weight, based on 100 parts by weight of halogen-containing polymer.

Fillers

Fillers such as calcium carbonate, dolomite, wollastonite, magnesium oxide, magnesium hydroxide, silicates, china clay, talc, glass fibres, glass beads, wood flour, mica, metal oxides or metal hydroxides, carbon black, graphite, rock flour, heavy spar, glass fibres, talc, kaolin and chalk are used. Preference is given to chalk (HANDBOOK OF PVC FORMULATING, E. J. Wickson, John Wiley & Sons, Inc., 1993, pp. 393-449) and reinforcing agents (TASCHENBUCH der Kunststoffadditive [Plastics Additives Handbook], R. Gächter & H. Müller, Carl Hanser, 1990, pp. 549-615).

The fillers may be used in amounts of preferably at least one part by weight, for example 5 to 200 parts by weight, expediently 10 to 150 parts by weight and in particular from 15 to 100 parts by weight, based on 100 parts by weight of PVC.

Metal Soaps

Metal soaps are primarily metal carboxylates, preferably of relatively long-chain carboxylic acids. Well-known examples of these are stearates, oleates, palmitates, ricinolates, hydroxystearates, dihydroxystearates and laurates, and also oleates and salts of relatively short-chain aliphatic or aromatic carboxylic acids, such as acetic acid, propionic acid, butyric acid, valeric acid, hexanoic acid, sorbic acid, oxalic acid, malonic acid, maleic acid, anthranilic acid, succinic acid, glutaric acid, adipic acid, fumaric acid, citric acid, benzoic acid, salicylic acid, phthalic acids, hemimellitic acid, trimellitic acid, pyromellitic acid.

Metals which should be mentioned are: Li, Na, K, Mg, Ca, Sr, Ba, Zn, Al, La, Ce and rare earth metals. Use is frequently made of so-called synergistic mixtures, such as barium/zinc stabilizers, magnesium/zinc stabilizers, calcium/zinc stabilizers or calcium/magnesium/zinc stabilizers. The metal soaps may be used either alone or in mixtures. An overview of common metal soaps is found in Ullmann's Encyclopedia of Industrial Chemistry, 5th Ed., Vol. A16 (1985), pp. 361 et seq.

The metal soaps or mixtures of these may be used in amounts of, for example, 0.001 to 10 parts by weight, expediently 0.01 to 8 parts by weight, particularly preferably 0.05 to 5 parts by weight, based on 100 parts by weight of PVC.

Alkali Metal and Alkaline Earth Metal Compounds

For the purposes of the present invention, these are mainly the carboxylates of the acids described above, but also corresponding oxides or, respectively, hydroxides or carbonates. Mixtures of these with organic acids are also possible. Examples are LiOH, NaOH, KOH, CaO, Ca(OH)₂, MgO, Mg(OH)₂, Sr(OH)₂, Al(OH)₃, CaCO₃ and MgCO₃ (and also basic carbonates, such as magnesia alba and huntite), and also fatty-acid salts of Na and of K. In the case of alkaline earth carboxylates and Zn carboxylates it is also possible to use adducts of these with MO or M(OH)₂ (M=Ca, Mg, Sr or Zn), so-called “overbased” compounds. In addition to the stabilizers according to the invention it is preferable to use alkali metal carboxylates, alkaline earth metal carboxylates and/or aluminium carboxylates.

Lubricants

Examples of possible lubricants are: fatty acids, fatty alcohols, montan wax, fatty acid esters, PE waxes, amide waxes, chloroparaffins, glycerol esters and alkaline earth metal soaps, and fatty ketones, and also the lubricants, or combinations of the lubricants, listed in EP 0 259 783. Stearic acid, stearic esters and calcium stearate are preferred.

Plasticizers

Examples of organic plasticizers are those from the following groups:

A) Phthalates: examples of these plasticizers are dimethyl, diethyl, dibutyl, dihexyl, di-2-ethylhexyl, di-n-octyl, diisooctyl, diisononyl, diisodecyl, diisotridecyl, dicyclohexyl, dimethylcyclohexyl, dimethylglycol, dibutylgycol, benzyl butyl and diphenyl phthalate, and also mixtures of phthalates, such as C₇-C₉- and C₉-C₁₁-alkyl phthalates composed of predominantly linear alcohols,

C₆-C₁₀-n-alkyl phthalate and C₈-C₁₀-n-alkyl phthalates. Among these, preference is given to dibutyl, dihexyl, di-2-ethylhexyl, di-n-octyl, diisooctyl, diisononyl, diisodecyl, diisotridecyl and benzyl butyl phthalate, and also to the mixtures mentioned of alkyl phthalates. Particular preference is given to di-2-ethylhexyl, diisononyl and diisodecyl phthalate, also known by the common abbreviations DOP (dioctyl phthalate, di-2-ethylhexyl phthalate), DINP (diisononyl phthalate), DIDP (diisodecyl phthalate).

B) Esters of aliphatic dicarboxylic acids, in particular esters of adipic, azelaic or sebacic acid: Examples of these plasticizers are di-2-ethylhexyl adipate, diisooctyl adipate (mixture), diisonoyl adipate (mixture), diisodecyl adipate (mixture), benzyl butyl adipate, benzyl octyl adipate, di-2-ethylhexyl azelate, di-2-ethylhexyl sebacate and diisodecyl sebacate (mixture). Preference is given to di-2-ethylhexyl adipate and diisooctyl adipate.

C) Trimellitic esters, such as tri-2-ethylhexyl trimellitate, triisodecyl trimellitate (mixture), triisotridecyl trimellitate, triisooctyl trimellitate (mixture), and also tri-C₆-C₈-alkyl, tri-C₆-C₁₀-alkyl, tri-C₇-C₉-alkyl and tri-C₉-C₁₁-alkyl trimellitate. The last-mentioned trimellitates are formed by esterification of trimellitic acid with the corresponding alkanol mixtures. Preferred trimellitates are tri-2-ethylhexyl trimellitate and the trimellitates mentioned obtained from alkanol mixtures. Common abbreviations are TOTM (trioctyl trimellitate, tri-2-ethylhexyl trimellitate), TIDTM (triisodecyl trimellitate) and TITDTM (triisotridecyl trimellitate).

D) Epoxy plasticizers: these are primarily epoxidized unsaturated fatty acids, e.g. epoxidized soybean oil.

E) Polymeric plasticizers: a definition of these plasticizers and examples of the same are given in “Kunststoffadditive” [Plastics Additives], R. Gächter and H. Müller, Carl Hanser Verlag, 3rd Edition, 1989, Chapter 5.9.6, pp. 412-415, and in “PVC Technology”, W. V. Titow, 4th Edition, Elsevier Publ., 1984, pp. 165-170. The commonest starting materials for preparing polyester plasticizers are: dicarboxylic acids, such as adipic, phthalic, azelaic or sebacic acid; diols, such as 1,2-propanediol, 1,3-butanediol, 1,4-butanediol, 1,6-hexanediol, neopentyl glycol and diethylene glycol.

F) Phosphoric esters: a definition of these esters is given in the abovementioned “Taschenbuch der Kunststoffadditive” [“Plastics Additives Handbook”], Chapter 5.9.5, pp. 408-412. Examples of these phosphoric esters are tributyl phosphate, tri-2-ethylbutyl phosphate, tri-2-ethylhexyl phosphate, trichloroethyl phosphate, 2-ethylhexyl diphenyl phosphate, cresyl diphenyl phosphate, triphenyl phosphate, tricresyl phosphate and trixylenyl phosphate. Preference is given to tri-2-ethylhexyl phosphate and ®Reofos 50 and 95 (Ciba Specialty Chemicals).

G) Chlorinated hydrocarbons (paraffins)

H) Hydrocarbons

I) Monoesters, e.g. butyl oleate, phenoxyethyl oleate, tetrahydrofurfuryl oleate and alkylsulphonates.

J) Glycol esters, e.g. diglycol benzoates.

K) Citric esters, e.g. tributyl citrate and tributyl acetylcitrate, as described in WO 02/05206.

L) Perhydrophthalic, -isophthalic and -terephthalic esters, and also the perhydrogenated glycol and diglycol benzoates. Preference is given to diisononyl perhydrophthalate (®Hexamoll DINCH-BASF), as described in DE 19.756.913, DE 19.927,977, DE 19.927.978 and DE 19.927.979.

A definition of these plasticizers and examples of the same are given in “Kunststoffadditive” (“Plastics Additives”], R. Gächter/H. Müller, Carl Hanser Verlag, 3rd Ed., 1989, Chapter 5.9.6, pp. 412-415, and in “PVC Technology”, W. V. Titow, 4th Ed., Elsevier Publ., 1984, pp. 165-170.

Definitions and examples of plasticizers of groups G) to J) can be found in the following manuals: “Kunststoffadditive” [“Plastics Additives”], R. Gächter and H. Müller, Carl Hanser Verlag, 3rd Edition, 1989, Chapter 5.9.14.2, pp. 422-425, (group G), and Chapter 5.9.14.1, p. 422, (group H).

“PVC Technology”, W. V. Titow, 4th Edition, Elsevier Publ., 1984, Chapter 6.10.2, pp. 171-173, (group G), Chapter 6.10.5 p. 174, (group H) Chapter 6.10.3, p. 173, (group I) and Chapter 6.10.4, pp. 173-174 (group J).

It is also possible to use mixtures of different plasticizers.

The plasticizers may be used in amounts of, for example, 5 to 20 parts by weight, expediently 10 to 20 parts by weight, based on 100 parts by weight of PVC. Rigid or semirigid PVC comprises preferably up to 10%, particularly preferably up to 5%, of plasticizer, or no plasticizer.

Pigments

Suitable substances are known to the skilled worker. Examples of inorganic pigments are TiO₂, pigments based on zirconium oxide, BaSO₄, zinc oxide (zinc white) and lithopones (zinc sulphide/barium sulphate), carbon black, carbon black-titanium dioxide mixtures, iron oxide pigments, Sb₂O₃, (Ti,Ba,Sb)O₂, Cr₂O₃, spinels, such as cobalt blue and cobalt green; Cd(S,Se), ultramarine blue. Examples of organic pigments are azo pigments, phthalocyanine pigments, quinacridone pigments, perylene pigments, diketopyrrolopyrrole pigments and anthraquinone pigments. TiO₂ in micronized form is also preferred. Mixtures of various pigments may also be used. A definition and further descriptions are found in the “Handbook of PVC Formulating”, E. J. Wickson, John Wiley & Sons, New York, 1993.

Phosphites (Triesters of Phosphorous Acid)

Organic phosphites are known costabilizers for chlorine-containing polymers. Examples of these are trioctyl, tridecyl, tridodecyl, tritridecyl, tripentadecyl, trioleyl, tristearyl, triphenyl, tricresyl, tris(nonylphenyl), tris(2,4-tert-butylphenyl) and tricyclohexyl phosphite.

Other suitable phosphites are various mixed aryl dialkyl or alkyl diarylphosphites, such as phenyl dioctyl, phenyl didecyl, phenyl didodecyl, phenyl ditridecyl, phenyl ditetradecyl, phenyl dipentadecyl, octyl diphenyl, decyl diphenyl, undecyl diphenyl, dodecyl diphenyl, tridecyl diphenyl, tetradecyl diphenyl, pentadecyl diphenyl, oleyl diphenyl, stearyl diphenyl and dodecyl bis(2,4-di-tert-butylphenyl) phosphite.

Advantageous use may also be made of phosphites of various di- or polyols: e.g. tetraphenyldipropylene glycol diphosphite, polydipropylene glycol phenyl phosphite, tetramethylolcyclohexanol decyl diphosphite, tetramethylolcyclohexanol butoxyethoxyethyl diphosphite, tetramethylolcyclohexanol nonylphenyl diphosphite, bis(nonylphenyl) di(trimethylolpropane) diphosphite, bis(2-butoxyethyl) di(trimethylolpropane) diphosphite, tris(hydroxyethyl)isocyanurate hexadecyl triphosphite, didecyl pentaerythrityl diphosphite, distearyl pentaerythrityl diphosphite, bis(2,4-di-tert-butylphenyl) pentaerythrityl diphosphite, and also mixtures of these phosphites and aryl/alkyl phosphite mixtures of empirical composition (H₁₉C₉—C₆H₄O)_{1.5}P(OC_{12,13}H_{25,27})_{1.5} or [C₈H₁₇—C₆H₄—O—]₂P[i-C₈H₁₇O], (H₁₉C₉—C₆H₄O)_{1.5}P(OCC_{9,11}H_{9,23})_{1.5}.

Industrial examples are Naugard P, Mark CH 300, Mark CH 301, Mark CH 302, Mark CH 304 and Mark CH 55 (products of Crompton Corporation).

Examples of total amounts of the organic phosphites used, or of mixtures thereof, are from 0.01 to 10 parts by weight, advantageously from 0.05 to 5, and in particular from 0.1 to 3 parts by weight, based on 100 parts by weight of PVC.

Metal Hydroxycarboxylates

Metal hydroxycarboxylates may also be present, and the metal here may be an alkali metal or alkaline earth metal or aluminium. Preference is given to sodium, potassium, magnesium or calcium. The hydroxycarboxylic acid may be glycolic, lactic, malic, tartaric or citric acid, or salicylic or 4-hydroxybenzoic acid, or else glyceric acid, gluconic acid and saccharic acid (see patent specification GB 1,694,873).

Epoxidized Fatty Acid Esters and Other Epoxy Compounds

The stabilizer combination of the invention may additionally and preferably comprise at least one epoxidized fatty acid ester. Possible compounds here are especially esters of fatty acids from natural sources (fatty acid glycerides), such as soya oil or rapeseed oil. However, it is also possible to use synthetic products, such as epoxidized butyl oleate.

Use may also be made of epoxidized polybutadiene and polyisoprene, if desired also in a partially hydroxylated form, or of glycidyl acrylate and glycidyl methacrylate as homo- or copolymer. These epoxy compounds may also have been applied to a laminar compound; in this connection see also DE-A-4 031 818. Examples of total amounts of the epoxy compounds used are preferably at least 0.1 part by weight, for example from 0.1 to 50 parts by weight, advantageously from 1 to 30 and in particular from 1 to 25 parts by weight, based on 100 parts by weight of PVC.

Antioxidants

Alkylated monophenols, e.g. 2,6-di-tert-butyl-4-methylphenol, alkylthiomethylphenols, e.g. 2,4-dioctylthiomethyl-6-tert-butylphenol, alkylated hydroquinones, e.g. 2,6-di-tert-butyl-4-methoxyphenol, hydroxylated thiodiphenyl ethers, e.g. 2,2′-thiobis(6-tert-butyl-4-methylphenol), alkylidenebisphenols, e.g. 2,2′-methylenebis(6-tert-butyl-4-methylphenol), benzyl compounds, e.g. 3,5,3′,5′-tetratert-butyl-4,4′-dihydroxydibenzyl ether, hydroxybenzylated malonates, e.g. dioctadecyl 2,2-bis(3,5-di-tert-butyl-2-hydroxybenzyl) malonate, hydroxybenzyl aromatics, e.g. 1,3,5-tris(3,5-di-tert-butyl-4-hydroxybenzyl)-2,4,6-trimethylbenzene, triazine compounds, e.g. 2,4-bisoctylmercapto-6-(3,5-di-tert-butyl-4-hydroxyanilino)-1,3,5-triazine, phosphonates and phosphonites, e.g. dimethyl 2,5-di-tert-butyl-4-hydroxybenzylphosphonate, acylaminophenols, e.g. 4-hydroxylauranilide, esters of beta-(3,5-ditert-butyl-4-hydroxyphenyl)propionic acid, beta-(5-tert-butyl-4-hydroxy-3-methylphenyl)propionic acid, beta-(3,5-dicyclohexyl-4-hydroxyphenyl)propionic acid, esters of 3,5-ditert-butyl-4-hydroxyphenylacetic acid with mono- or polyhydric alcohols, amides of beta-(3,5-ditert-butyl-4-hydroxyphenyl)propionic acid, such as, for example, N,N′-bis(3,5-ditert-butyl-4-hydroxyphenylpropionyl)hexamethylenediamine, vitamin E (tocopherol) and derivatives. Mixtures of the antioxidants may also be used.

Industrial examples are Naugard 10, Naugard 76, Naugard BHT and Naugard 45 (products of Crompton Corporation). Examples of the amounts of the antioxidants used are from 0.01 to 10 parts by weight, advantageously, from 0.1 to 10 parts by weight and in particular from 0.1 to 5 parts by weight, based on 100 parts by weight of PVC.

UV Absorbers and Light Stabilizers

Examples of these are: 2-(2′-hydroxyphenyl)benzotriazoles, such as 2-(2′-hydroxy-5′-methylphenyl)benzotriazole, 2-hydroxybenzophenones, esters of unsubstituted or substituted benzoic acids, such as 4-tert-butylphenyl salicylate, phenyl salicylate, acrylates, nickel compounds, oxalamides, such as 4,4′-dioctyloxyoxanilide, 2,2′-dioctyloxy-5,5′-ditertbutyloxanilide, 2-(2-hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, sterically hindered amines, such as bis(2,2,6,6-tetramethylpiperidin-4-yl) sebacate, bis(2,2,6,6-tetramethylpiperidin-4-yl) succinate. Mixtures of the UV absorbers and/or light stabilizers may also be used.

Blowing Agents

Examples of blowing agents are organic azo compounds and organic hydrazo compounds, tetrazoles, oxazines, isatoic anhydride, and also soda and sodium bicarbonate. Preference is given to azodicarbonamide and sodium bicarbonate and also mixtures of these.

Definitions for and examples of impact modifiers and processing aids, gelling agents, antistats, biocides, metal deactivators, optical brighteners, flame retardants, antifogging agents and compatibilizers are given in “Kunststoffadditive” [“Plastics Additives”], R. Gächter/H. Müller, Carl Hanser Verlag, 3rd and 4th Ed., 1989 and 2001, and in “Handbook of Polyvinyl Chloride Formulating”, E. J. Wilson, J. Wiley & Sons, 1993, and also in “Plastics Additives”, G. Pritchard, Chapman & Hall, London, 1st edition, 1998. Impact modifiers are also described in detail in “Impact Modifiers for PVC”, J. T. Lutz/D. L. Dunkelberger, John Wiley & Sons, 1992.

Use may be made of one or more additives and/or mixtures thereof may be used.

The invention also provides compositions which comprise a chlorine-containing polymer and a stabilizer system of the invention.

The invention also provides compositions which comprise a chlorine-containing polymer and a stabilizer system of the invention in addition to one or more other components from one of the groups exemplified by glycidyl compounds, phosphites, hydroxycarboxylates, hydrotalcites, zeolites, and alkali metal and alkaline earth metal compounds and epoxidized fatty esters.

The amounts of these compounds of the general formulae (I), (II), (III) and (IV) present for stabilization in these chlorine-containing polymer compositions are advantageously from 0.01 to 10 parts by weight, preferably from 0.05 to 5 parts by weight, in particular from 0.1 to 2 parts by weight based on 100 parts by weight of PVC.

Examples of the amount used of the perfluoroalkane-sulphonate compounds are from 0.001 to 5 parts by weight, advantageously from 0.01 to 3 parts by weight, particularly preferably from 0.01 to 2 parts by weight, based on 100 parts by weight of PVC.

The co-additives such as glycidyl compounds, phosphites, hydroxycarboxylates, hydrotalcites, zeolites, and alkali metal and alkaline earth metal compounds and epoxidized fatty esters are used at from 0.01 to 15 parts by weight, preferably from 0.1 to 10 parts by weight, in particular from 2 to 3 parts by weight.

Examples of the chlorine-containing polymers to be stabilized are:

polymers of vinyl chloride, of vinylidene chloride, vinyl resins whose structure contains vinyl chloride units, such as copolymers of vinyl chloride and vinyl esters of aliphatic acids, in particular vinyl acetate, copolymers of vinyl chloride with esters of acrylic or methacrylic acid and with acrylonitrile, copolymers of vinyl chloride with diene compounds and with unsaturated dicarboxylic acids or anhydrides of these, such as copolymers of vinyl chloride with diethyl maleate, diethyl fumarate or maleic anhydride, postchlorinated polymers and copolymers of vinyl chloride, copolymers of vinyl chloride and vinylidene chloride with unsaturated aldehydes, ketones and others, such as acrolein, crotonaldehyde, vinyl methyl ketone, vinyl methyl ether, vinyl isobutyl ether and the like; polymers of vinylidene chloride and copolymers of the same with vinyl chloride and with other polymerizable compounds; polymers of vinyl chloroacetate and of dichlorodivinyl ether; chlorinated polymers of vinyl acetate, chlorinated polymeric esters of acrylic acid and of alpha-substituted acrylic acid; polymers of chlorinated styrenes, such as dichlorostyrene; chlorinated rubbers; chlorinated polymers of ethylene; polymers and postchlorinated polymers of chlorobutadiene and copolymers of these with vinyl chloride, chlorinated natural or synthetic rubbers, and also mixtures of the polymers mentioned with themselves or with other polymerizable compounds. For the purposes of this invention, PVC includes copolymers with polymerizable compounds, such as acrylonitrile, vinyl acetate or ABS, where these may be suspension polymers, bulk polymers or else emulsion polymers. Preference is given to a PVC homopolymer, also in combination with polyacrylates.

Other possible polymers are graft polymers of PVC with EVA, ABS or MBS. Other preferred substrates are mixtures of the abovementioned homo- and copolymers, in particular vinyl chloride homopolymers, with other thermoplastic or/and elastomeric polymers, in particular blends with ABS, MBS, NBR, SAN, EVA, CPE, MBAS, PMA, PMMA, EPDM or with polylactones, in particular from the group consisting of ABS, NBR, NAR, SAN and EVA. The abbreviations used for the copolymers are familiar to the skilled worker and have the following meanings: ABS: acrylonitrile-butadiene-styrene; SAN: styrene-acrylonitrile; NBR: acrylonitrile-butadiene; NAR: acrylonitrile-acrylate; EVA: ethylene-vinyl acetate. Other possible polymers are in particular styrene-acrylonitrile copolymers based on acrylate (ASA). A preferred component in this context is a polymer composition which comprises, as components (i) and (ii), a mixture of 25-75% by weight of PVC and 75-25% by weight of the copolymers mentioned. Components of particular importance are compositions made from (i) 100 parts by weight of PVC and (ii) 0-300 parts by weight of ABS and/or SAN-modified ABS and 0-80 parts by weight of the copolymers NBR, NAR and/or EVA, but in particular EVA.

For the purposes of the present invention it is also possible to stabilize in particular recycled materials of chlorine-containing polymers, specifically the polymers described in more detail above, which have been degraded by processing, use or storage. Recycled material from PVC is particularly preferred.

The compounds which may be used concomitantly according to the invention, and also the chlorine-containing polymers, are well known to the skilled worker and are described in detail in “Kunststoffadditive” [“Plastics Additives”], R. Gächter/H. Müller, Carl Hanser Verlag, 3rd and 4th Ed., 1989 and 2001; in DE 197 41 778 and in EP 967 245, which are incorporated herein by way of reference.

The stabilization according to the invention is particularly advantageous for rigid PVC formulations for transparent and non-transparent applications, as are common in pipes, profiles and sheets. For transparent applications, use is preferably made of compounds of the formula (I), (II), (III) or (IVb) which have a melting point below about 190° C. The stabilization is also useful for semirigid and flexible formulations, and also in plastisols. The stabilization requires no heavy metal compounds (Sn stabilizers, Pb stabilizers, Cd stabilizers, Zn stabilizers) and is particularly highly suitable for producing physiologically acceptable consumer products from PVC, including products for medical use.

The stabilizer systems may advantageously be incorporated by the following methods: as emulsion or dispersion; as a dry mixture during the mixing of added components or polymer mixtures; by direct addition into the processing apparatus (e.g. calender, mixer, kneader, extruder or the like) or as a solution or melt or, respectively, as flakes or pellets in a dust-free form as one-pack.

The PVC stabilized according to the invention, which is also provided by the invention, may be prepared in a manner known per se, by using equipment known per se, such as the abovementioned processing apparatus, to mix the stabilizer system of the invention and, if desired, other additives, with the PVC. The stabilizers here may be added individually or in a mixture, or else in the form of what are known as masterbatches.

The PVC stabilized as in the present invention may be brought into the desired shape in a known manner.

Examples of processes of this type are grinding, calendering, extruding, injection moulding and spinning, and also extrusion blowmoulding. The stabilized PVC may also be processed to give foams.

A PVC stabilized according to the invention is, particularly suitable for example, for hollow articles (bottles), packaging films (thermoformed films), blown films, pipes, foams, heavy profiles (window frames), translucent-wall profiles, construction profiles, sidings, fittings, office sheeting and apparatus housings (computers, household devices).

Preference is given to rigid PVC foam moldings and PVC pipes, for example for drinking water or wastewater, pressure pipes, gas pipes, cable-duct pipes and cable-protection pipes, pipes for industrial pipelines, drainpipes, outflow pipes, gutter pipes and drainage pipes.

The PVC stabilized according to the invention is also particularly suitable for semirigid and flexible formulations, in particular in the form of flexible formulations for wire sheathing, cable insulation, flooring, wallpapers, motor vehicle components, flexible films, injection mouldings or hoses, these being particularly preferred. The inventive PVC in the form of semirigid formulations is particularly suitable for decorative films, foams, agricultural films, hoses, sealing profiles and office films. Examples of the use of the inventive PVC as plastisol are synthetic leather, flooring, textile coatings, wallpapers, coil-coating materials and underbody protection for motor vehicles.

For more detail in this connection see “Kunststoffhandbuch PVC” [“Plastics Handbook PVC”], Vol 2/2, W. Becker/H. Braun, 2nd Ed., 1985, Carl Hanser Verlag, pp. 1236-1277.

The examples below illustrate the invention but do not restrict the same. As in the remainder of the description, parts and percentages given are based on weight.

### EXAMPLES

TABLE 1
Organic stabilizers

| Stabilizer | Formula |
|---|---|
| 1 | 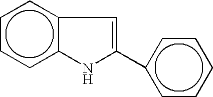 |
| 2 | 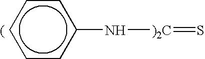 |
| 3 | N—(CH₂—CH₂—OH)₃ |
| 4a | 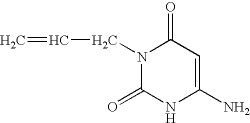 |
| 4b | 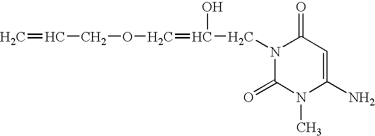 |
| 5 | 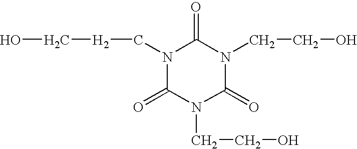 |

### Example 1

### Static Heat Test

A dry mixture composed of

| | | |
|---|---|---|
| 100.0 | parts of | Evipol (trademark of EVC) SH 5730 - |
| | | PVC, K value 57 |
| 5.0 | parts of | Paraloid (trademark of Röhm & Haas) |
| | | BTA 7805 = MBS (methyl methacrylate- |
| | | butadiene-styrene) modifier |
| 0.5 | part of | Paraloid (trademark of Röhm & Haas) |
| | | K 120 N = acrylate processing aid |
| 0.5 | part of | Paraloid (trademark of Röhm & Haas) |
| | | K 175 N = acrylate processing aid |
| 1.0 | part of | Loxiol G 16 = partial fatty ester of |
| | | glycerol (from Henkel) |
| 0.3 | part of | Wachs E = ester wax (Montane wax) (from |
| | | BASF) |
| 3.0 | parts of | ESO = epoxidized soybean oil |
| 0.1 | part of | magnesium laurate |
| x | parts of | sulphonate = 30% strength solution of |
| | | Na trifluoromethanesulphonate in |
| | | butyldiglycol |

and 0.6 part of the stabilizers stated in table 1 were rolled on mixing rolls at 180° C. for 5 minutes. The test strips of film, thickness 0.3 mm, were taken from the resultant milled sheet. The film specimens were heated in an oven (=Mathis Thermo-Takter) at 190° C. At 3-minute intervals the Yellowness Index (YI) was determined to ASTM D1925-70. The results are found in table 2. Low YI values mean good stabilization.

TABLE 2

| | Stab. | | | | | | | | | | |
|---|---|---|---|---|---|---|---|---|---|---|---|
| | — | 1 | 1 | 2 | 2 | 4a | 4a | 4b | 4b | 5 | 5 |
| | x parts | | | | | | | | | | |
| | 0.1 | — | 0.1 | — | 0.2 | — | 0.05 | — | 0.17 | — | 0.2 |
| Min | YI value | | | | | | | | | | |
| 0 | 58.39 | 18.21 | 15.76 | 33.84 | 21.35 | 9.00 | 8.66 | 7.16 | 7.35 | 37.88 | 23.95 |
| 3 | 65.46 | 20.30 | 18.20 | 50.59 | 29.74 | 12.09 | 9.77 | 7.81 | 8.14 | 39.63 | 26.39 |
| 6 | 72.50 | 30.64 | 24.07 | 87.68 | 42.68 | 15.44 | 12.29 | 9.14 | 10.26 | 72.04 | 39.93 |
| 9 | 85.48 | 52.23 | 40.12 | 146.02 | 61.76 | 19.41 | 15.57 | 12.68 | 13.98 | 114.20 | 66.33 |
| 12 | 103.52 | 78.93 | 55.32 | | 83.03 | 23.61 | 20.01 | 18.74 | 17.38 | | 92.39 |
| 15 | | 107.93 | 70.99 | | 106.73 | 30.26 | 25.49 | 27.91 | 24.80 | | 103.67 |
| 18 | | | 88.06 | | | 38.58 | 32.90 | 42.36 | 32.64 | | |
| 21 | | | 107.54 | | | 57.00 | 42.20 | 62.90 | 40.86 | | |
| 24 | | | 100.70 | | | 89.17 | 56.56 | 89.15 | 52.39 | | |
| 27 | | | | | | 182.84 | 75.42 | 129.83 | 64.95 | | |
| 30 | | | | | | | 124.91 | | 81.14 | | |
| 33 | | | | | | | | | 97.82 | | |
| 36 | | | | | | | | | 118.78 | | |

Comments
Table 2 clearly shows that addition of Na triflate to each type of stabilizer results in a significant improvement in initial colour, colourfastness and long-term stability.

### Example 2

### Static Heat Test

A dry mixture composed of

| | | |
|---|---|---|
| 100.0 | parts of | Evipol (trademark of EVC) SH 7020 - |
| | | PVC, K value 70 |
| 47.0 | parts of | Dioctyl phthalate |
| 3.0 | parts of | ESO = epoxidized soybean oil |
| 0.3 | part of | Loxiol ® G 71 S = pentaerythritol adipate |
| | | complex ester - lubricant |
| 0.1 | part of | Calcium stearate |
| x | parts of | sulphonate = 30% strength solution of |
| | | Na trifluoromethanesulphonate |

and 0.27 part of the stabilizers stated in table 1 were rolled on mixing rolls at 180° C. for 5 minutes. The test strips of film, thickness 0.5 mm, were taken from the resultant milled sheet. The film specimens were heated in an oven (=Mathis Thermo-Takter) at 190° C. At 3-minute intervals the Yellowness Index (YI) was determined to ASTM D1925-70. The results are found in table 2. Where appropriate, 0.6 part of CH 300=mixed aryl/alkyl phosphite from Crompton was added (cf. table 3) to the mixture. Low YI values mean good stabilization.

TABLE 3

Stab.

| | | | |
|---|---|---|---|
| 3 | 3 | 3 | 3* |

X part of sulphonate

| | | | |
|---|---|---|---|
| — | 0.2 | 0.3 | 0.3 |

| | |
|---|---|
| Min | YI value |

| | | | | |
|---|---|---|---|---|
| 0 | 17.00 | 6.97 | 6.50 | 5.79 |
| 3 | 20.28 | 7.42 | 7.66 | 5.53 |
| 6 | 30.21 | 9.97 | 9.95 | 5.96 |
| 9 | 49.09 | 16.45 | 15.76 | 6.49 |
| 12 | 66.58 | 18.12 | 19.12 | 7.33 |
| 15 | 88.15 | 16.15 | 16.53 | 9.20 |
| 18 | 109.5 | 17.96 | 20.85 | 11.77 |
| 21 | | 28.08 | 30.04 | 19.06 |
| 24 | | 42.97 | 46.09 | 40.68 |
| 27 | | 65.75 | 68.70 | 61.56 |
| 30 | | 85.49 | 85.09 | 77.85 |
| 33 | | 95.11 | 96.11 | 86.55 |
| 36 | | 104.69 | 105.88 | 94.57 |
| 39 | | | | 100.83 |

*+0.6 part of CH 300 = mixed aryl/alkyl phosphite from Crompton
Comments:
Table 3 shows that addition of Na triflate results in an improvement in thermal stabilizing action, which can be further improved via phosphite addition.

### Example 3

### Static Heat Test (TK 101 7790)

A dry mixture composed of

| | | |
|---|---|---|
| 100.0 | parts of | Evipol (trademark of EVC) SH 5730 - |
| | | PVC, K value 57 |
| 5.0 | parts of | Paraloid (trademark of Röhm & Haas) |
| | | BTA 7805 = MBS (methyl methacrylate- |
| | | butadiene-styrene) modifier |
| 0.5 | part of | Paraloid (trademark of Röhm & Haas) |
| | | K 120 N = acrylate processing aid |
| 0.5 | part of | Paraloid (trademark of Röhm & Haas) |
| | | K 175 N = acrylate processing aid |
| 1.0 | part of | Loxiol G 16 = partial fatty ester of |
| | | glycerol (from Henkel) |
| 0.3 | part of | Wachs E = ester wax (Montane wax) (from |
| | | BASF) |
| 3.0 | parts of | ESO = epoxidized soybean oil |
| x | parts of | sulphonate = 30% strength solution of |
| | | Na trifluoromethanesulphonate in |
| | | butyldiglycol |

and 0.3 part of the stabilizers stated in table 1 were rolled on mixing rolls at 180° C. for 5 minutes. The test strips of film, thickness 0.3 mm, were taken from the resultant milled sheet. The film specimens were heated in an oven (=Mathis Thermo-Takter) at 190° C. At 3-minute intervals the Yellowness Index (YI) was determined to ASTM D1925-70. The results are found in table 4. Low YI values mean good stabilization.

TABLE 4

Stab.

| | |
|---|---|
| 3 | 3 |

X parts of sulphonate

| | |
|---|---|
| — | 1.0 |

| | |
|---|---|
| Min | YI value |

| | | |
|---|---|---|
| 0 | 45.9 | 14.12 |
| 3 | 54.1 | 18.18 |
| 6 | 77.45 | 21.99 |
| 9 | 111.6 | 28.13 |
| 12 | | 38.20 |
| 15 | | 53.15 |
| 18 | | 73.60 |
| 21 | | 91.47 |
| 24 | | 105.39 |

Comments:
Addition of Na triflate gives a clear improvement in thermal stabilizing action as described in table 4.

1. A stabilizer system for stabilizing halogen-containing polymers against thermal degradation, comprising
(a) at least one perfluoroalkanesulphonate salt and
(b) at least one or more indoles and/or ureas and/or alkanolamines and/or aminouracils,
wherein the indoles have the general formula (I) 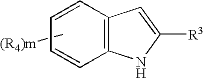
wherein m is 0, 1, 2 or 3; R³ is C₁-C₁₈ alkyl, C₂-C₁₈ alkenyl, phenyl or 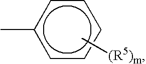
C₇-C₂₄ alkylphenyl, C₇-C₁₀ phenylalkyl or C₁-C₄ alkoxy;
R⁴ and R⁵ are H, C₁-C₄ alkyl, or C₁-C₄ alkoxy;
where wherein the ureas have the general formula (II) 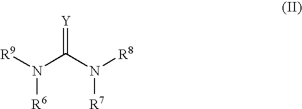
wherein Y is O, S or NH; R⁶, R⁷, R⁸ and R⁹, independently of one another, are H, C₁-C₁₈ alkyl optionally substituted with hydroxyl groups and/or C₁-C₄ alkoxy groups, C₂-C₁₈ alkenyl, phenyl optionally substituted with up to 3 hydroxy and/or C₁-C₄ alkyl/alkoxy groups, C₇-C₂₀ alkylphenyl or C₇-C₁₀ phenylalkyl, and 2-substituents selected from R⁶ to R⁹ may also form a ring, or a dimerized or trimerized urea thereof, and reaction products thereof,
wherein the alkanolamines have the formula (III) 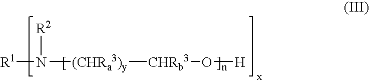
wherein x is 1, 2 or 3; y is 1, 2, 3, 4, 5 or 6; n is 1-10;
R¹ and R² independently of one another are H, C₁-C₂₂alkyl, —[—(CHR³ₐ)_{y}—CHR³_{b}—O—]ₙ—H, —[—(CHR³ₐ)_{y}—CHR³_{b}—O—]ₙ—CO—R⁴, C₂-C₂₀ alkenyl, C₂-C₁₈ acyl, C₄-C₈ cycloalkyl, which may have OH substitution in the β-position, phenyl, C₇-C₁₀ alkylphenyl or C₇-C₁₀ phenylalkyl, or if x=1, R¹ and R² may also form, together with the N atom to which each is bonded to, a closed 4-10 membered ring of carbon atoms optionally containing up to 2 heteroatoms, or if x=2, R¹ may be C₂-C₁₈ alkylene which may have OH substitution at the two β-carbon atoms and/or may have interruption by one of more O atoms and/or by one or more NR₂ groups, dihydroxy-substituted tetrahydrodicyclopentadienylene, dihydroxy substituted ethylcyclohexanylene, dihydroxy-subsituted 4,4′-(bisphenol-A-dipropyl ether)ylene, isophoronylene, dimethylcyclohexanylene, dicyclohexylmethanylene or 3,3′-dimethyldicyclohexylmethanylene, or if x=3, R¹ may be a trihydroxy-subsituted (tri-N-propyl isocyanurate)triyl; R³ₐ and R³_{b} independently of one another are C₁-C₂₂ alkyl, C₂-C₆ alkenyl, phenyl, C₆-C₁₀ alkylphenyl, H or CH₂—X—R⁵, wherein X is O, S, —O—CO— or —CO—O—; R⁴is C₁-C₁₈ alkyl, alkenyl or phenyl; and R⁵ is H, C₁-C₂₂ alkyl, C₂-C₂₂ alkenyl, phenyl or C₆-C₁₀ alkylphenyl,
and the aminouracils have the formula (IVa) or (IVb) 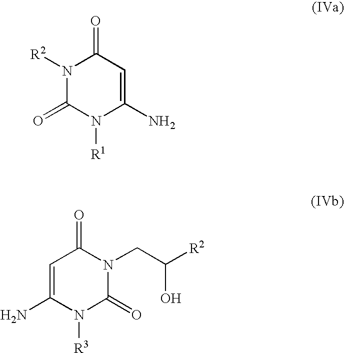
wherein in the case of (IVa) R¹ and R², independently of one another, are H, unsubstituted C₁-C₄alkyl-, C₁-C₄ alkoxy- and/or hydroxyl-substituted phenyl, or are phenyl-C₁-C₄alkyl which is unsubstituted or has C₁-C₄alkyl, C₁-C₄alkoxy and/or hydroxyl substitution on the phenyl ring, C₃-C₆alkenyl, C₅-C₈cycloalkyl, or are C₃-C₁₀alkyl interrupted by at least one oxygen atom, or are CH₂—CHOH—R₃, wherein R₃ is H, C₁-C₄alkyl, C₂-C₄alkenyl, C₄-C₈cycloalkyl, phenyl, C₇-C₁₀alkylphenyl or C₇-C₁₀phenylalkyl, and in the case of N- or N′-monosubstituted aminouracils R¹ or R² is C₃-C₂₂alkyl, and in the case of (IVb) R² is H, C₁-C₄alkyl, C₂-C₄alkenyl, C₄-C₈cycloalkyl, phenyl, C₆-C₁₀alkylphenyl, C₇-C₁₀phenylalkyl, —CH₂—X—R⁴, wherein R⁴ is H, a C₁-C₁₀alkyl, a C₂-C₄alkenyl radical or C₄-C₈-cycloalkyl, where appropriate also containing an oxirane ring; or where appropriate substituted with from 1 to 3 C₁-C₄alkyl radicals, or with a benzoyl radical or a C₂-C₁₈acyl radical, and X is O or S; R³=R² or R⁴; C₂-C₆alkyl substituted with at least 1-5 OH groups and/or interrupted by at least 1 to a 4 O atoms, or is CH₂—CH(OH)R².

2. The stabilizer system according to claim 1, wherein the perfluoroalkanesulphonate salt is a salt of a metal selected from the group consisting of Li, Na, K, Mg, Ca, Sr, Ba, Sn, Zn, Al, La and Ce.

3. The stabilizer system according to claim 1, where in the compound having the general formula (I) R³ is phenyl, in the compound having the general formula (II), R⁶, R⁷, R⁸ and R⁹ independently are phenyl or H, in the compound having the general formula (III) n is 1 and y is 2 or 3, in the compound having the general formula (IVa) R¹ and R² independently are H, C₂-C₄alkenyl or C₃-C₁₀alkyl and in the compound having the general formula (IVb) R³ is methyl or benzyl and R² is C₂-C₈alkyl, C₃-C₆alkenyl or (C₁-C₈-alkoxy)methyl.

4. The stabilizer system according to claim 1, where in the perfluoroalkanesulphonate salt is sodium triflate or potassium triflate.

5. The stabilizer system according to claim 1, wherein the indoles of the general formula (I) are 2-phenylindole or 2-phenyllaurylindole, the ureas of the general formula (II) are N,N′-diphenylthiourea, N-phenylurea, trishydroxyethyl or trishydroxypropyl isocyanurate, the alkanolamines of the general formula (III) are reaction products of NH₃, or of primary or secondary amines, with ethane oxide, propene oxide, butane oxide or (thiol)glycidyl ethers or are reaction products of (thio)glycidyl ethers with alkanolamines, in the compounds of the general formula (IVa) R¹ and R² independently are H, allyl, propyl or butyl, and in the compounds of the general formula (IVb) R³ is methyl and R² is ethyl or allyloxymethyl.

6. The stabilizer system according to claim 4, wherein at least one compound of the formula (IVa) is present and wherein R¹ and R² are C₁-C₂₂alkoxy or oleyl, and this aminouracil may be partially or entirely replaced by a corresponding structurally isomeric cyanoacetylurea.

7. The stabilizer system according to claim 1, further comprising metal soaps, polyols, disaccharide alcohols, glycidyl compounds, hydrotalcites, alkali metal/alkaline earth metal aluminosilicates, alkali metal/alkaline earth metal hydroxides, alkaline earth metal oxides, alkaline earth metal (hydrogen) carbonates, alkali metal (alkaline earth metal) hydroxycarboxylates or carboxylates, phosphates, plasticizers, antioxidants, fillers, pigments, light stabilizers, lubricants, epoxidized fatty esters and mixtures thereof.

8. The stabilizer system according to claim 1, further comprising a phosphate.

9. A composition comprising a chlorine-containing polymer and the stabilizer system according to claim 1.

10. The composition according to claim 9, comprising from 0.01 to 10 parts by weight of the compounds of the general formula (I) and/or (II) and/or (III) and/or (IVa) and/or (IVb) and from 0.001 to 5 parts by weight of the perfluoroalkanesulphonate salt based on 100 parts by weight of the chlorine-containing polymer.

11. A process for stabilizing a chlorine-containing polymer against thermal degradation, the process comprising adding the stabilizer system according to claim 1 to the chlorine-containing polymer.

12. A consumer product comprising a polyvinyl chloride and the stabilizer system according to claim 1.

13. The stabilizer system according to claim 1, wherein component b is 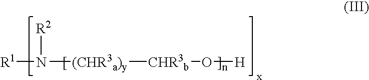
for prestabilizing polyvinyl chloride against thermal induced degradation.

14. The composition according to claim 9, wherein the chlorine-containing polymer is selected from the group consisting of a polymer of vinyl chloride, polymer of vinylidene chloride, polymer of a vinyl resin containing vinyl chloride units, copolymer of vinyl chloride with a diene compound and an unsaturated carboxylic acid or anhydride thereof, post chlorinated polymer or copolymer of vinyl chloride, copolymer of vinyl chloride and vinylidene chloride with an unsaturated aldehyde or ketone, polymer of vinyl chloroacetate and a dichlorodivinyl ether, chlorinated polymer of vinyl acetate, chlorinated polymeric ester of acrylic acid and an alpha-substituted acrylic acid, polymer of a chlorinated styrene, chlorinated rubber, chlorinated polymer of ethylene, polymer or post-chlorinated polymer of chlorobutadiene or a copolymer thereof with vinyl chloride or a chlorinated natural or synthetic rubber and mixtures thereof.

15. The process according to claim 11, wherein the chlorine-containing polymer is selected from the group consisting of a polymer of vinyl chloride, polymer of vinylidene chloride, polymer of a vinyl resin containing vinyl chloride units, copolymer of vinyl chloride with a diene compound and an unsaturated carboxylic acid or anhydride thereof, post chlorinated polymer or copolymer of vinyl chloride, copolymer of vinyl chloride and vinylidene chloride with an unsaturated aldehyde or ketone, polymer of vinyl chloroacetate and a dichlorodivinyl ether, chlorinated polymer of vinyl acetate, chlorinated polymeric ester of acrylic acid and an alpha-substituted acrylic acid, polymer of a chlorinated styrene, chlorinated rubber, chlorinated polymer of ethylene, polymer or post-chlorinated polymer of chlorobutadiene or a copolymer thereof with vinyl chloride or a chlorinated natural or synthetic rubber and mixtures thereof.
